(19) United States
(12) Patent Application Publication
(10) Pub. No.: US 2007/0194548 A1
(43) Pub. Date: Aug. 23, 2007

(54) GeoSledd

(76) Inventor: George T. Coleman, Costa Mesa, CA (US)

Correspondence Address: GEORGE T. COLEMAN, 1919 WALLACE AVE #103, COSTA MESA, CA, 92627, US

(21) Appl. No.: 11/642,495

(22) Filed: Mar. 12, 2007

Related U.S. Application Data
(60) Provisional application No. 60/775,862, filed on Feb. 23, 2006.

(51) Int. Cl. B62M 1/00

(52) U.S. Cl. 280/87.042

(57) ABSTRACT

As a technical disclosure, I submit that the GeoSledd frame is tubular steel. The front, single steel tube is 1 and ½″ diameter with ⅛″- 3/16″ wall and the double rear steel tubes are 1″ diameter with ⅛″- 3/16″ wall. The two brackets that join the front and rear tubes are 1 and ½″ steel in an L-shape with ⅛″ thickness. The front fork and steering components are standard bicycle parts. The deck that the rider stands on is a wooden skateboard deck. The freewheeling front and rear wheels are 26″×2.125 bicycle wheels and tires. The overall weight of the GeoSledd is approximately 25 lbs.

### REFERENCE

Provisional Patent Application No. 60/775,862, dated Feb. 23, 2006.

The GeoSledd is a hybrid piece of equipment that combines the elements of a traditional bicycle and a skateboard. It is made by using a three-part tubular steel frame that is welded together through a pair of steel brackets located under the skateboard deck. This tubular frame is then connected/welded to a traditional bicycle front end. There are full-size (26″) bicycle wheels and tires at the front and the rear. The operator/rider stands on the skateboard deck and provides power and forward motion by pushing off with one foot while the other, non-pushing foot maintains solid footing on the skateboard deck.

### BRIEF DESCRIPTION OF DRAWINGS

FIG. 1

This is the original concept sketch that was drawn before any materials had been specified/chosen or actual work done.

FIG. 2

This is a top view of the structural configuration and the connections that join the single, larger diameter front tube with the double, smaller diameter rear tubes to form the complete tube frame.

FIG. 3

This is a top view, CAD-rendering of the tube frame.

FIG. 4

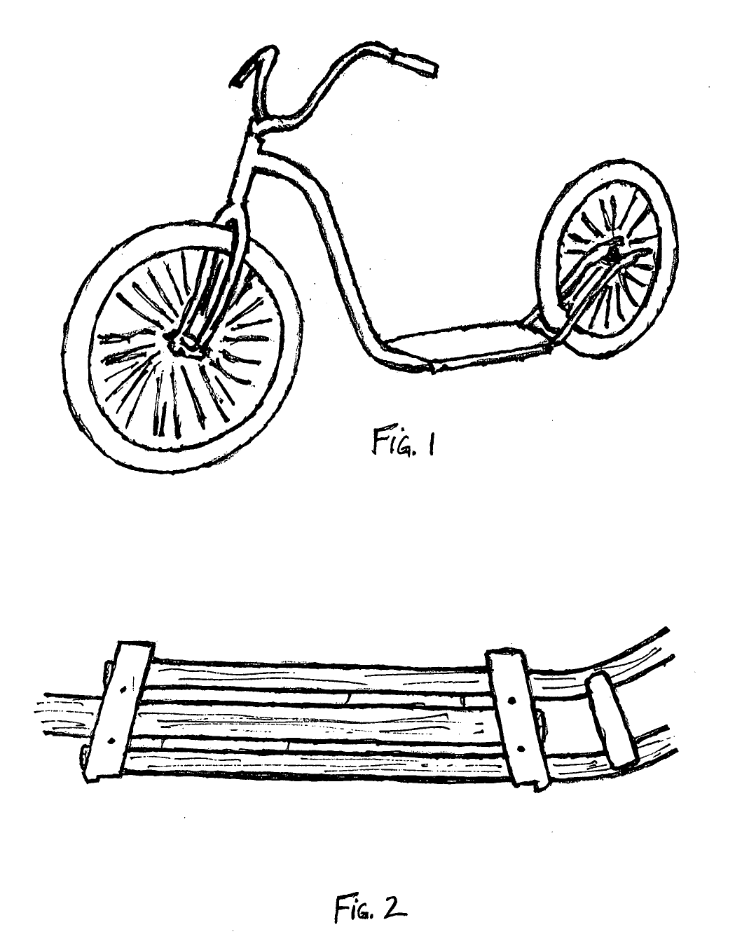

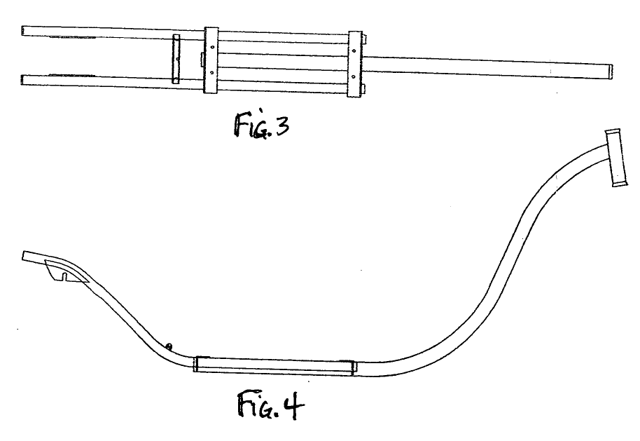

This is a side view, CAD-rendering of the tube frame.

1. I claim that the purpose of the GeoSledd is to be used as a leisure, recreational and exercise piece of equipment.
